(19) United States
(12) Patent Application Publication
(10) Pub. No.: US 2008/0073150 A1
(43) Pub. Date: Mar. 27, 2008

(54) Safety Reinforcing Structure for Aluminum Ladder Hinge

(76) Inventor: Fan Nan LIN, Taipei (TW)

Correspondence Address: Richard Chen, 7F., No. 122 Sung Chiang Rd., Taipei, omitted

(21) Appl. No.: 11/535,489

(22) Filed: Sep. 27, 2006

(51) Int. Cl. E06C 1/00

(52) U.S. Cl. 182/163; 182/22

(57) ABSTRACT

The invention provides aluminum ladder hinge with enhanced safety structure. The hinge is made of flat inner case and outer case. Especially, the hinge has a locking block design to stabilize the angle of opening and closure. There is also a design of a joint reinforcing disk and a reinforcing tab to enhance the guiding groove and reduce friction loss. There is also design of prolonged caps and a rectangular hole, liner to strengthen the assembly of the hinge and the aluminum ladder. Based on the above designs, an advanced aluminum ladder hinge with enhanced safety structure is invented to improve the safety of aluminum ladder in use.

### BACKGROUND OF THE INVENTION

1. Field of the Invention

The invention is related to structural design for aluminum ladder hinge. Especially, it refers to an aluminum ladder hinge with several safety reinforcing functions.

2. Description of the Prior Art

Because aluminum folding ladder appears in “A” letter shape during use and is folded in “I” letter shape in assembly or after use, it offers lightweight and convenience to users and is widely accepted. As shown in FIG. 3, it is a traditional aluminum ladder hinge (1). The hinge (1) is comprised of one flat inner case and one flat outer case (2, 3). On top of the inner case (2), the round joint (20) has several notches (201), while the outer case (3) has a latch (314) for folding the aluminum ladder. The end of the latch (314) is linked to and also drives a resilient locking block (304). The locking block (304) can be set into or detached from the notch (201) of the round joint (20). Further through the interaction between the round joint (20) and the joint disk (30), multiple opening angles for the hinge (1) can be achieved. Although such hinge (1) has provided a certain level of convenience in use and does not seem to cause problems, some potential risk exists due to improper structural design for traditional aluminum ladders. There is a need for adding safety to structural design for ladders. It is explained in the following:

1. Structural Design Flaw for Locking Block:

The traditional locking block (304) adopting “advance to lock, back to open” as control method for the hinge (1) has its shape in rectangular A locking block or trapezoidal B locking block. Please refer to FIG. 1 and FIG. 2. Simple rectangular A locking block has the drawback: the gap will increase because the rectangular A locking block slides back and forth in the guiding groove (301) of the joint disk (30), which is the main cause to unstable quality in locking; while the trapezoidal B locking block has more prominent locking and positioning effect on “advance to lock” than the rectangular A locking block, it still can not achieve fastness during “back to open”; instead, it enlarges the gap and causes unstable locking.

2. Insufficient Strength for Hinge, Notch and Guiding Groove:

Traditional round joint (20) is shown as in FIG. 3. Because each impact concentrates on a single notch (201) when the locking block (304) is set in, the notch (201) is susceptible to damage, and as a result, there is safety concern due to increasingly fast damage to the round joint (20). Also because the locking block (304) slides back and forth in the guiding groove (301), it is susceptible to attrition and the gap is increasing.

3. Insufficient Strength for the Aluminum Ladder Leg at Point of Applied Force:

Traditional hinge (1) is shown in FIG. 3 and FIG. 4. After the caps (21, 31) in the lower part of the inner and outer case (2, 3) are inserted into the aluminum ladder leg (4), the place that the aluminum ladder leg (4) is not coupled with the caps (21, 31) is the point of applied force (41) when the aluminum ladder leg (4) is subject to forces due to opening and closure of the hinge (1) and the weight of the aluminum ladder itself. After a long term of use, the point of applied force (41) for the aluminum ladder leg (4) is susceptible to metal fatigue and damage, and as a result, the aluminum ladder may break. This is its major drawback.

Thus, product improvement lies in its practical value. How to increase the practical value and the safety, and gain customer recognition is the objective the industry is seeking to achieve.

In view of this, the inventor with dedication in serving the public and many years of experiences in design and manufacturing of aluminum folding ladder has devoted to overcoming the drawbacks for the traditional aluminum ladder and developing and testing new design. Finally, the inventor had this invention.

### SUMMARY OF THE INVENTION

The main objective for the invention is to provide aluminum ladder hinge with enhanced safety structure through improved safet and structural design.

Another objective for the invention is to provide aluminum ladder hinge with enhanced safety structure, so not only the original designed function can be maintained but also the added safety measures and devices meet all testing specifications and practical needs.

To achieve the above objectives, the safety enhancing structure for aluminum ladderhinge provided by the invention uses the aluminum ladder hinge as basic structure, and at the same time adds a few functions to the hinge, which include: (1) locking block design to stabilize the angle of opening and closure for the hinge; (2) joint reinforcing disk and notch reinforcing tab design to enhance structural strength for the round joint and its notch; (3) guiding groove reinforcing tab design to enhance the structural strength for the guiding groove and reduce friction loss; and (4) extended cap and its rectangular hole, liner design to enhance the assembly strength for the hinge and the aluminum ladder leg; so the integrated design can provide the aluminum ladder hinge with enhanced safety structure to replace the traditional design.

To allow patent examiners to further understand the invention, a preferred embodiment with figures, symbols description is explained in the following for its structure and benefits:

### BRIEF DESCRIPTION OF THE DRAWINGS

FIG. 1 is an illustration for a locking block of the aluminum ladder hinge in use.

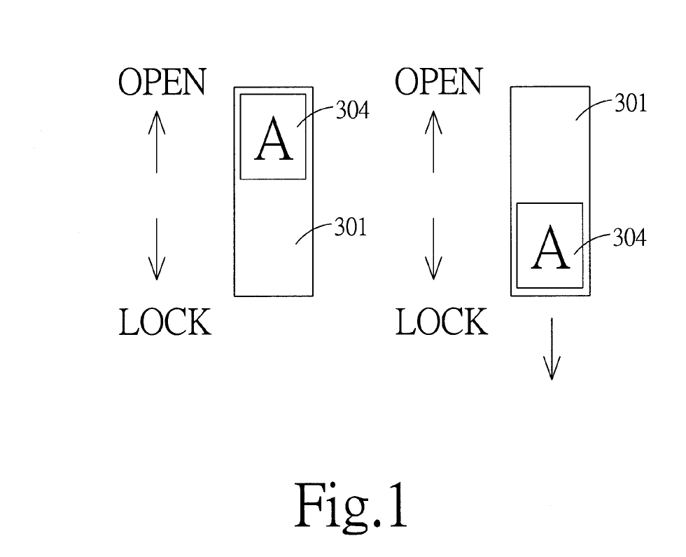

FIG. 2 is an illustration for another locking block of the aluminum ladder hinge in use.

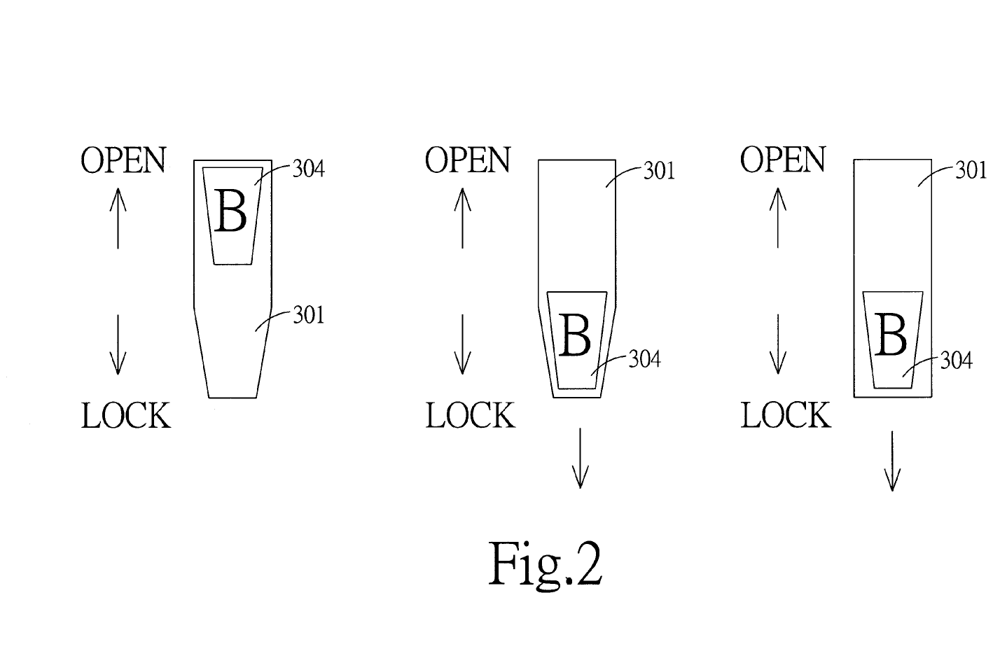

FIG. 3 is the exterior structural diagram for traditional aluminum ladder hinge.

FIG. 4 is a side view for traditional aluminum ladder.

FIG. 5 is a disassembly diagram for the inner case for the aluminum ladder hinge.

FIG. 6 is a disassembly diagram for the outer case for the aluminum ladder hinge.

FIG. 7 the exterior structural diagram for the aluminum ladder hinge in the invention.

FIG. 8 is a two-dimensional diagram for the locking block for the aluminum ladder hinge in the invention.

FIG. 9 is the exterior structural diagram for the aluminum ladder in the invention.

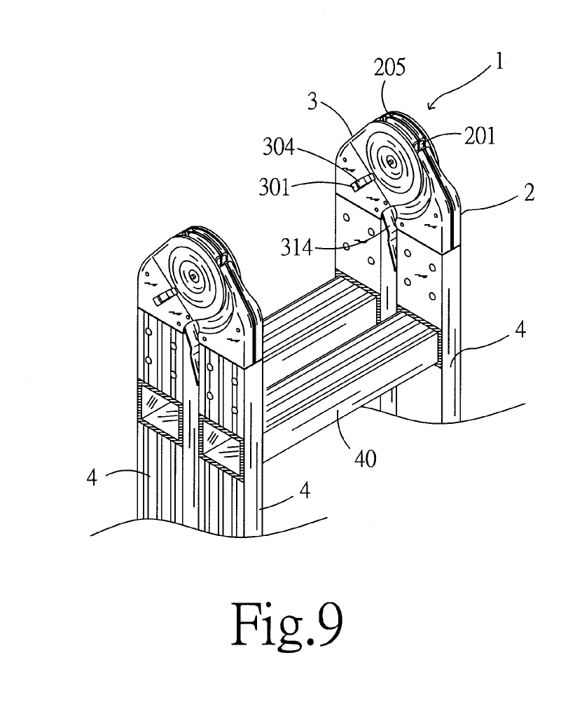

FIG. 10 is the side view for the aluminum ladder in the invention.

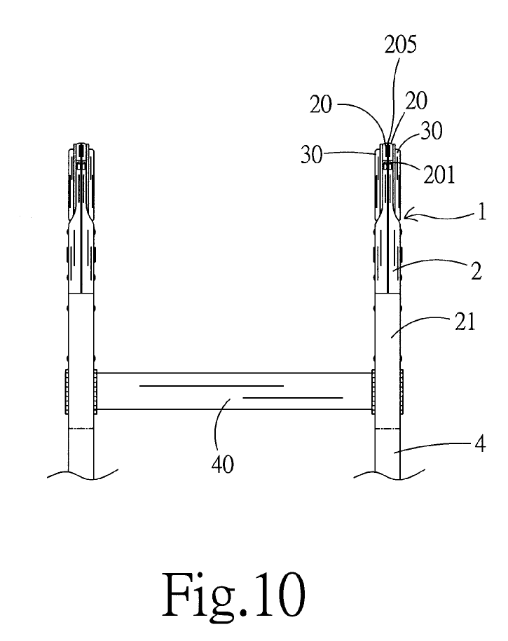

### DETAILED DESCRIPTION OF THE PREFERRED EMBODIMENTS

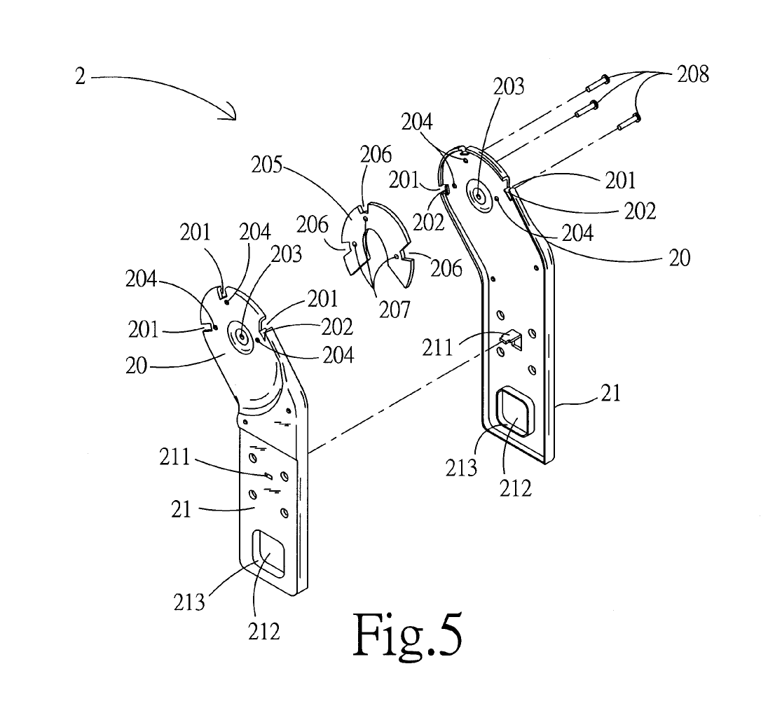

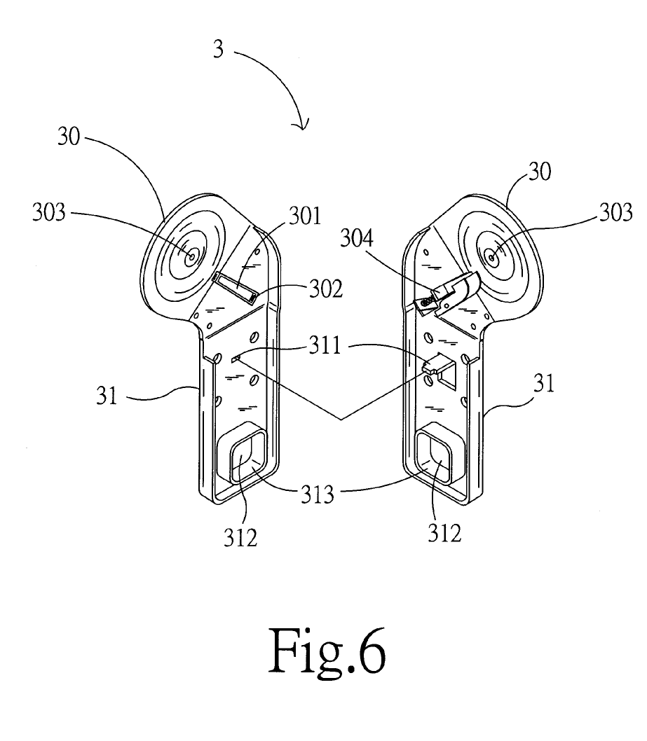

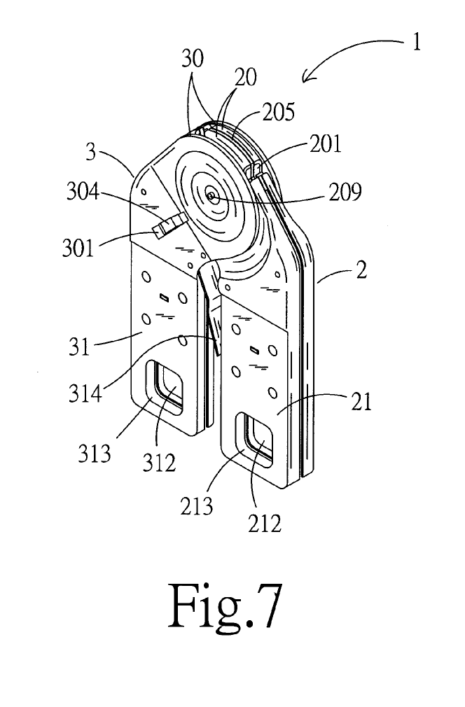

Please refer to FIG. 5, FIG. 6 and FIG. 7. The enhanced safety structure provided for the aluminum ladder hinge in the invention is a hinge (1) that is mainly composed of an inner case and an outer case (2, 3).

As shown in FIG. 5 and FIG. 6, either of the inner case and the outer case (2, 3) is made of one flat piece on the right and one flat piece on the left. Through the design of the buckle (211, 311) which is on the top of inner side of the caps (21, 31) for the inner and the outer cases (2, 3), the two flat pieces for either the inner or the outer case (2, 3) can achieve combination with improved efficiency and accuracy. After the two flat pieces for the inner case or the outer case (2, 3) are combined, a round joint (20) with several notches (201) separated in equal distance is formed on the top section of the inner case (2) and is inserted between the two joint disks (30) on the top section of the outer case (3). In the round joint (20), there adds a joint reinforcing disk (205) with several notches (206) separated in equal distance. Besides, pivots (208) are used through the through-holes (204, 207) to fasten the joint reinforcing disk (205) and the round joint (20). More pivots (209) through the through-holes (203, 303) are used to fasten the inner and the outer cases (2, 3). On the other hand, on the lower section of the inner and the outer cases (2, 3) there are caps (21, 31) to be coupled with one end of the aluminum ladder leg (4). Further, the outer case (3) has a latch (314) to fold the aluminum ladder, as shown in FIG. 7. The end of the latch (314) is linked and drives a resilient locking block (304) that can slide in the guiding groove. The locking block (304) can be set into or detached from the notches (201, 206) of the round joint (20) and the joint reinforcing disk (205). It is the interaction between the round joint (20) and the joint disk (30) to control the angle of opening and closure in multiple stages for the hinge (1).

The above is the introduction for the basic structure for the aluminum ladder hinge in the invention. The main features for the invention are described as follows:

(A). Change the Shape Design for the Locking Block:

Rectangular (304) or trapezoidal locking block (304) design.

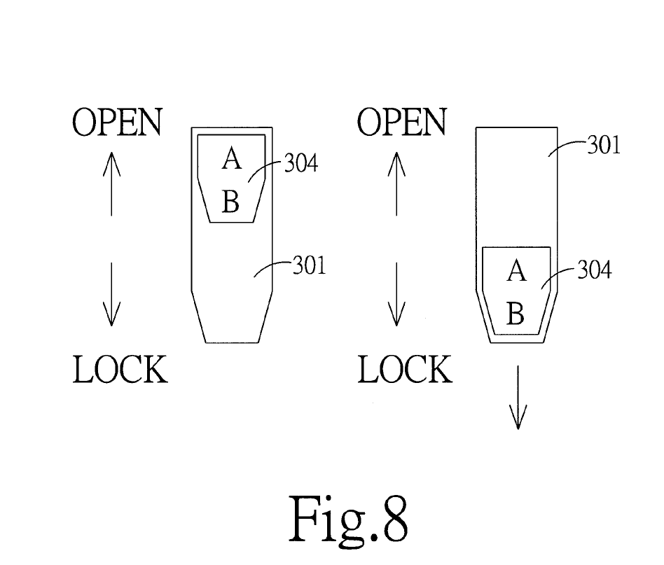

At the end of the latch (314) for the outer case (3) as shown in FIG. 7, the locking block (304) is integrated and appears in the shape of a AB locking block that is trapezoid in its front and rectangle in its back (as shown in FIG. 8). This is a completely new design over traditional pure rectangle for A locking block or pure trapezoid for B locking block. The guiding groove (301) on the outer case (3) for the locking blocks to slide over is also made to fit with their shape. Therefore, when the locking block (304) is detached from the notches (201, 206) of the round joint (20) and the joint reinforcing disk (205), it can slide smoothly in the guiding groove (301). When the locking block (304) is set firmly into the notch (201, 206), it forms no gap with the guiding groove (301). As a result, once the entire hinge (1) is open and positioned, its inner and outer cases (2, 3) will not be loose anymore.

(B). Add the Design of a Reinforcing Tab to the Hinge, the Notches and the Guiding Groove:

For round joint (20) of the Inner Case (2), as shown in FIG. 5, there adds notches (206) at equal distance for the joint reinforcing disk (205) and a notch reinforcing tab (202) on the inner side of the peripheral notch (201). For the outer case (3), as shown in FIG. 6, the guiding groove (301) for one joint disk (30) also adds a reinforcing tab (302). The added joint reinforcing disk (205) and the notch reinforcing tab (202) can strengthen the round joint (20) and the notch (201) and increase the resistance for the two devices under the impact by the locking block (304). On the other hand, the added reinforcing tab (302) can strengthen the guiding groove (301) and reduce its friction loss with locking block (304).

(C). Prolong the Cap and Add Coupling Hole and Liner Design:

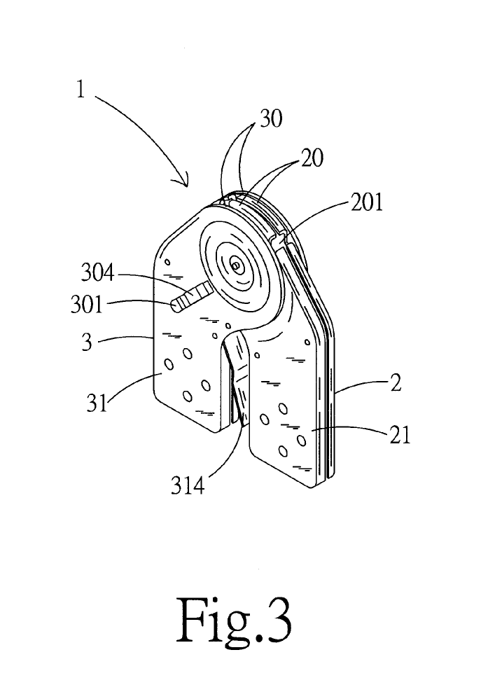

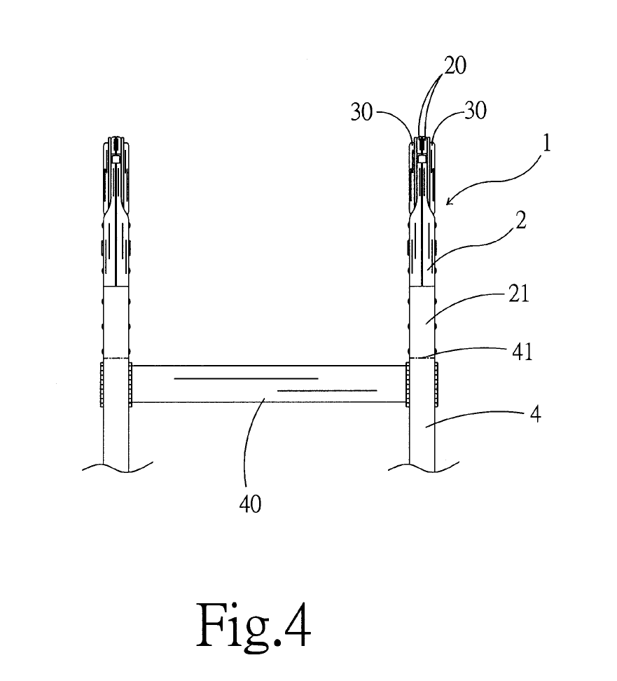

Traditional aluminum ladder, as shown in FIG. 3 and FIG. 4, in assembly, uses one end of the aluminum ladder lag (4) to couple with the caps (21, 31) at the lower section of the inner and the outer case (2, 3). The assembly also uses pivots for positioning and combination. But because the point of applied force (41) on the aluminum ladder leg (4) is susceptible to metal fatigue and breakage and causes accidents, there is safety concern. The desired method is shown in FIG. 7, which has prolonged caps (21, 31) at the lower section of the inner and the outer cases (2, 3) for the hinge (1). Besides, the shell of the extended caps (21, 31) adds rectangular liners (213, 313) and rectangular holes (212, 312). This allows the caps (21, 31) at the lower section of the inner case and the outer case (2, 3) be coupled with the aluminum ladder leg (4) and the first rung (40) through the rectangular liners (213, 313) and the rectangular holes (212, 312) to strengthen the assembly of the inner case and the outer case (2, 3) of the hinge (1) and the aluminum ladder leg (4). This design can avoid the most fragile point of applied force (41) in the traditional aluminum ladder leg (4) and further assure the safety for the aluminum ladder.

All the additional structural designs on the hinge (1) are to strengthen the hinge and assure its safety in practical use.

What is claimed is:

1. An enhanced safety structure for aluminum ladder hinge is made of a hinge that is composed of one inner case and one outer case; the top half of the inner case is a round joint, which peripheral has notches at equal distance; each notch has added a notch reinforcing tab and a joint reinforcing disk, which can be inserted between the two joint disks in the top half of the outer case; the bottom half of the inner and the outer cases have caps, which can be coupled with the aluminum ladder leg and the first rung; on the outer case there is a latch to fold the aluminum ladder; the end of the latch is linked to and drives a resilient locking block that can slide in the guiding groove; it can be set into or detached from the notch of the round joint and the joint reinforcing disk in the inner case; the interaction between the round joint and the joint disk is to control the opening and closure of the hinge at multiple angles; the features to the invention are:
on an outer case, the end of the latch to fold the ladder is linked to a locking block, which is integrated to be trapezoid in the front half and rectangle in the rear half; the guiding groove at the joint disk of the outer case is also made to fit in shape; so when the locking block is set firmly into the notch, there is no gap with the guiding groove, and the hinge after opening and positioning will not be loose anymore.

2. As described in claim 1 for an enhanced safety structure for the aluminum ladder hinge, the round joint adds a joint reinforcing disk with several notches at equal distance and reinforcing tab in the notch to strengthen the round joint and the notch.

3. As described in claim 1 for an enhanced safety structure for the aluminum ladder hinge, the guiding groove of the joint disk adds a reinforcing tab to strengthen the guiding groove and reduce the friction loss with the locking block.

4. As described in claim 1 for an enhanced safety structure for the aluminum ladder hinge, prolonged caps are added in the bottom half of the inner and the outer cases and the rectangular liner and the rectangular hole on the wall are used to be coupled with the first rung of the aluminum ladder leg to strengthen the assembly of the hinge and the aluminum ladder leg.
